(19) United States
(12) Patent Application Publication
(10) Pub. No.: US 2004/0261605 A1
(43) Pub. Date: Dec. 30, 2004

(54) Method and device both for prolonging the longevity of tuning, and enhancing the sound quality in a unison stringed instrument

(76) Inventor: M. Scott Jones, Boalsburg, PA (US)

Correspondence Address: Pamela A. Ruest, Esquire, McQuaide Blasko, 811 University Drive, State College, PA, 16801, US

(21) Appl. No.: 10/824,801

(22) Filed: Apr. 15, 2004

Related U.S. Application Data
(60) Provisional application No. 60/463,372, filed on Apr. 15, 2003.

(51) Int. Cl. G10G 7/02

(52) U.S. Cl. 84/455

(57) ABSTRACT

The invention provides a simple, cost effective, easy-to-install device to significantly prolong the longevity of a piano tuning, and the tuning of any unison stringed instrument. According to the invention, unison strings can be mechanically linked or coupled to align portions of their oscillatory patterns. This alignment reduces the aural perception of unison distuning. The alignment can also produce a more consistent rate of amplitude attack and amplitude decay among linked strings. The alignment can permit the use of previously unavailable multi-string pitch adjustment devices.

### REFERENCE TO RELATED APPLICATIONS

This application claims the benefit of U.S. Provisional Patent Application No. 60/463,372 filed Apr. 15, 2003.

### FIELD OF THE INVENTION

This invention relates to the field of stringed instruments, and more particularly, to the fields of prolonging the tuning of a unison stringed instrument such as a piano, and of enhancing the sound qualities of the instrument.

### BACKGROUND OF THE INVENTION

The modern piano employs highly tensioned steel wires or strings to produce musical sounds. Strings are typically grouped together with one, two or three strings for each individual note. The number of strings per note is predetermined by the manufacturer in order to produce a well balanced scale throughout the instrument. Most modern pianos include three-string notes (referred to herein as trichords) in well over half of the keyboard usually about sixty notes. Two-string notes (referred to herein as bichords) are found in the mid to lower register and number about twenty. The remaining notes are single strings in the lowest part of the scale. FIG. 1 (Prior Art) shows a typical tuning pin/string assembly for a trichord note. Each string is rigidly fastened at its ends with one end being attached to a tuning pin. This pin can be rotated to increase or decrease the string's tension, resulting in a change in vibrational frequency or pitch of the string. This process is known as tuning. Although this invention is directed primarily to pianos, the invention may be used in connection with any musical instrument containing bichords and trichords, including a mandolin, harpsichord and twelve string guitar.

The process of tuning a piano requires a trained technician to adjust the tension of each individual string to fit within a precise pitch schedule. When tuning a piano string, the tuner must first isolate it from the other strings within a note. This is ordinarily done through means of a soft rubber or felt wedge which absorbs the vibrational energy of the strings being silenced. FIG. 2 (Prior Art) shows typical string muting configurations. FIG. 2 shows two common methods for muting or silencing trichord strings in order to isolate individual strings. FIG. 2A shows a soft, acoustically absorbent material such as felt or rubber wedged between two strings in a three-string unison. In this case, only the far right string would be heard. FIG. 2B shows how felt or rubber strips are woven between groups of three-string unisons to silence the outer strings of each unison. In this case, only the center string of each unison would be heard. After a single string has been tuned, other strings can be tuned to it by selectively removing the mute wedges, thus revealing other string pitches for adjustment. Through this process of muting and revealing, each string of the piano can be isolated and properly tuned.

The pitch schedule is adjusted in two distinct layers. First, a single string from each note is adjusted, relative to the other notes. This process is known as setting the temperament. Next, a second layer of tuning follows—that of tuning the other strings within that same note (or string unison) to the identical frequency. This process is known as unison tuning. When complete, a piano will contain eighty-eight notes set at their proper frequencies, with almost every note containing multiple strings tuned to the same frequencies.

The pitch of each string is highly dependent upon its tension. A piano is always under a varying stress. The strings are stretched at an average tension of from one hundred and fifty to two hundred pounds each. Accordingly, the iron plate, together with the heavy wooden framing, carries a strain totaling from eighteen to twenty tons. The cumulative tensile load within a typical piano can in some instances exceed 40,000 lbs. of compressive force. This contrast between delicately balanced frequencies and massive load constraints is the reason all piano tunings represent only a temporary state of equilibrium. Even a well-tuned, high quality piano in a controlled environment is gradually and constantly drifting out of tulle. Such distuning can be heard in two distinct layers. First and almost immediately, individual notes will exhibit unison distuning as the strings within a typical bichord or trichord begin to produce slightly different frequencies. Over time, larger pitch changes will upset the relationships between notes, resulting in temperament distuning.

For ordinary piano use, it is generally accepted that a piano tuning will hold well for three to six months. From a strictly scientific point of view, however, no piano has stayed in tune, without a drop or a rise, for more than twenty-four hours, unless it was maintained at constant temperature and at constant barometric and hygroscopic conditions. Such conditions, of course, are difficult to maintain.

There are several factors that can alter the tuning of a piano: humidity, temperature, moving, excessively hard playing, aged or worn materials, and abuse.

Humidity fluctuation is the primary and most prevalent cause of changes in piano tuning. When the wooden soundboard, pinblock and bridge are in a moist environment, their wood cells absorb the moisture and swell, and as they expand they pull the strings tighter, causing the piano to go sharp. Logically, if the piano moves to a drier atmosphere, the wood shrinks, the strings loosen and go flat. Every seasonal change alters a piano's tuning.

Temperature is related to humidity. When the steel strings are heated, they loosen and go flat. When they get cold, they tighten and the piano goes sharp. Every environmental change, winter and summer, day and night, the temperature is in constant flux.

Moving a piano can cause distuning. The position of the tuning pins in the pinblock and the wires over the bridge pins is quite sensitive. Any time a piano is tilted, there is a shift in these positions.

Excessively hard playing also causes a piano to go out of tune when the force of the hammer is strong enough to actually stretch the speaking length of the string beyond the frictional constraints of its termination points.

Many materials in a piano can become aged or worn. Stress bearing wooden parts associated with tuning stability are particularly vulnerable. For example, the pinblock can become split, or the tuning pins can become loose in their holes from repeated tunings or wood shrinkage or deterioration. The bridges can split, usually along the line of the bridge pins; as the strings are tightened during tuning, the pins then move, compromising string stability. Sometimes metal string termination surfaces can bend or move as well. Additionally, new instruments tend to have less tuning stability because the strings are still stretching. Consequently, many piano manufacturers recommend four tunings in the first year, and two to three per year for the next five years.

Currently, there are five primary means for keeping a piano in tune: location, humidity control, frequent tuning, selective dampening, and electronic devices.

First, the location of the instrument is important. The ideal situation for a piano or stringed instrument is a room with constant temperature and humidity. However, this is extremely rare, and to achieve such an environment is cost prohibitive.

Second, internal humidity control within a piano is now a possibility. A piano equipped with a humidity-control device will extend the tuning of a piano. However, these systems are expensive, and require elaborate installations. In addition, the devices and systems may be considered inconvenient due to the requirement of regular maintenance and servicing. The systems require electric power, frequent replenishing of a water reservoir, and can malfunction from hard water sources and other environmental factors.

Third, frequent tuning enables a piano to sound its best. However, frequent tuning can be expensive, and can result in significant inconvenience to the piano's owner.

Fourth, there exist available techniques for mechanically repressing the unwanted effects of unison distuning in pianos. Most commonly, soft, dampening materials can be placed strategically between the strings of a piano, therein rendering the distuned strings silent. While this procedure does reduce distuning, it also significantly reduces the piano's volume and quality of tone. These techniques are reserved primarily for drastic environmental conditions.

Fifth, there exist complicated electronic systems that correct tuning instabilities. As one example, the Gilmore patent U.S. Pat. No. 6,479,738 describes a system using over 200 magnetic pickups to produce separate electronic signals that are transmitted to an automatic tuning device that compensates for tuning instabilities. The automatic tuning device such as set forth in Gilmore patent U.S. Pat. No. 5,756,913 uses actuated push/pull solenoids to automatically adjust separate string pitches. However, these patents are uniformly limited to separately tuning each string of a unison, and do not have the benefits or ease of installation of the subject invention. The Gilmore patents require a highly complex installation of systems and ongoing maintenance, and cannot be retrofit to existing pianos. It is cost prohibitive technology in almost all applications.

There are a variety of other electronic devices used to assist a professional piano tuner in tuning a piano. For instance, U.S. Pat. No. 5,285,711 to Inventronics, U.S. Pat. No. 5,719,343 to Reyburn, and U.S. Pat. No. 6,613,971 to Carpenter disclose related methods. However, no other known devices or methods exist that actually prolong the tuning of a piano or other unison stringed instrument.

In addition to these five approaches, manufacturers have attempted to develop new technologies for piano construction to help maintain tuning stability. Special pinblocks have been developed that incorporate numerous plies of high quality hardwoods. The plies are permanently bonded with proprietary resin glues to provide increased “wear” characteristics. However, even pianos with these enhanced materials and technology require frequent tuning, as the pinblocks and pins do not address the main source of distuning, as discussed above.

Thus, there is a need for a practical, inexpensive method and device to prolong the tuning of a piano or other stringed instrument with string unisons. There is additional need for such a device and method that is easy to install and remove, and that does not in any way alter or change the instrument itself.

### SUMMARY OF THE INVENTION

The invention provides a simple, cost effective, easy-to-install device to significantly prolong the longevity of a piano tuning, and the tuning of any unison stringed instrument. According to the invention, unison strings can be mechanically linked or coupled to align portions of their oscillatory patterns. This alignment reduces the aural perception of unison distuning. The alignment can also produce a more consistent rate of amplitude attack and amplitude decay among linked strings. The alignment can permit the use of previously unavailable multi-string pitch adjustment devices.

### BRIEF DESCRIPTION OF THE DRAWINGS

FIG. 1 shows a theoretical cross section of a piano, specifically illustrating a three string unison note configuration.

FIG. 2 shows two common methods for muting or silencing strings in order to isolate individual strings.

FIG. 3 shows different embodiments of the invention.

FIG. 4 depicts a cross-sectional view of two tensioned strings connected by a rigid banding link. Dotted cross-sections show the equilibrium position of the tensioned strings, indicating that the link is compressing the strings toward each other.

FIG. 5 depicts a rigid bracing link. Dotted cross-sections show the equilibrium position of the tensioned strings, indicating that the link is compressing the tensioned strings away from each other.

FIG. 6 depicts an overhead view of tensioned strings connected by a rigid link (A) or coupling. The two strings share a single tension adjustment device (B).

FIG. 7 depicts a semi-rigid link that is employed to permit assimilation of only certain frequencies, dependent upon the resonance and transmission properties of the link.

FIG. 8 shows small wire bending pliers being used to crimp a metal link onto strings.

FIG. 9 shows alternate embodiments of the preferred metal links.

FIG. 10 shows a typical muting pattern when tuning coupled strings.

FIG. 11 shows an overhead view of a three-string unison with tuning pins (A), two speaking length terminations (B), a coupling link (C) and hitch pins (D). Additionally, the note contains two crimping bands in the nonspeaking portion of the string (E).

FIG. 12 shows the general dimensions and configuration of a standard Pitchlock coupling.

FIG. 13 shows the preferred installation tool used to place a Pitchlock coupling at the correct location along the string length.

FIG. 14 contains data from a comparison of non coupled unison strings and coupled unison strings.

### DETAILED DESCRIPTION OF THE INVENTION

The invention relates to two or more tensioned strings in a musical instrument. A tensioned string is a closed-end bar, typically narrow and uniform in diameter. The ends of a tensioned string are fastened to opposing pulling forces. The sum of the pulling forces, in conjunction with string size and string stiffness, determines the amount of tension contained within the string system. A tensioned string can oscillate at a fixed frequency usually referred to as the fundamental frequency. Furthermore, segments of a tensioned string will oscillate as well, producing a harmonic series of overtones or partial tones whose frequencies are higher than, and proportional to the fundamental tone.

In the case of tensioned strings in musical instruments, the generation of a fundamental frequency, in combination with all dependent overtones, produces a musical pitch. The string pitch schedules for musical instruments are precisely calculated to minimize the presence of harmonically irregular combinations of pitches. Typically, each musical instrument string is equipped with a device which can alter the string's physical properties, thus permitting adjustment of the string's pitch. This type of adjustment, known as tuning, is common and necessary since stringed musical instruments are always, to some degree, dimensionally unstable when exposed to environmental variables such as temperature, atmospheric humidity, chemical corrosion and the like. These changes upset the delicate balance of the instrument string pitch schedules, thus necessitating tuning.

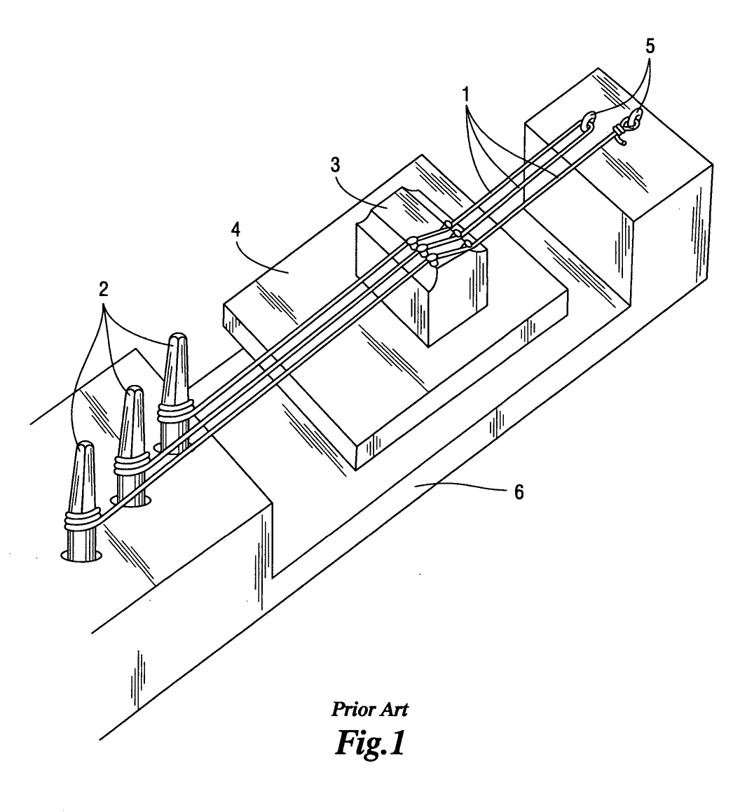

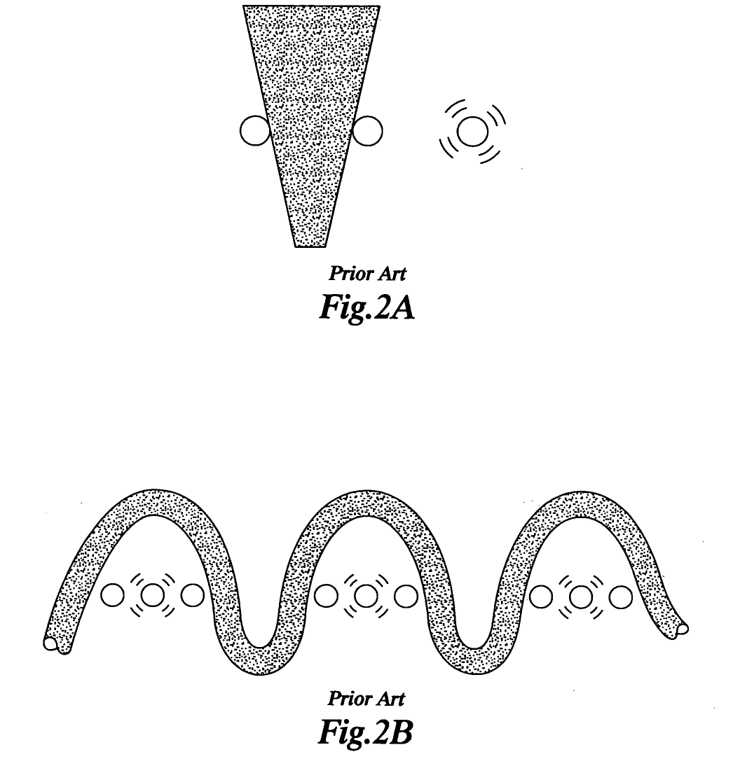

FIG. 1 shows a theoretical cross section of a piano, specifically illustrating a three-string unison note configuration. The three strings (A) are tuned to the same tension and frequency by turning tuning pins (B). The strings pass over a bridge (C) which transmits their frequencies into a soundboard (D). The strings are anchored to hitch pins (E) at their tail ends. String tension is resisted by an iron plate (F). Other tuning mechanisms are well known in the art, including those commonly used in mandolins and guitars.

The process of tuning is especially pertinent in those instruments which employ more than one string to produce a pitch. Instruments such as the piano, harpsichord, mandolin and twelve string guitar contain groups of two or more strings which are tuned to the same fundamental frequency. Each group, whether a bichord or trichord, produces a single pitch. A unison provides a wider dynamic range than a single string counterpart and is, therefore, a desirable feature in certain musical applications. A unison, however, is highly susceptible to tuning disturbances since the string frequencies within the unison must be so closely aligned. This susceptibility to distuning is even more apparent among the higher frequency overtones of each string within a unison. The prevalence of unison distuning is particularly significant in pianos which typically contain hundreds of tensioned strings and approximately eighty multi-string unison groups.

In the prior art description, a stringed musical instrument employs oscillating strings of predetermined size and tension to produce musical pitches. Distuning between string systems occurs when the string frequency schedules are disturbed by external factors some of which are described above. In those cases where unison string groupings are present, the adverse effects of distuning are particularly pervasive.

General Description of Coupling Device

In general terms, the invention consists of a floating link or coupling placed between or around two unison strings. The coupling does not contact any surfaces other than the joined strings. The coupling dimensions withstand the tensile and/or compressive forces of the associated strings. The coupling material properties exhibit a chosen stiffness to weight ratio, thereby minimizing the dampening effects of the added coupling mass to the string systems. The placement of the coupling is adjustable and, preferably, in close proximity to a string termination, thereby reducing the mechanical leverage of the coupling mass and, again, minimizing the dampening effect of the coupling. The coupling provides a medium through which oscillatory forces of each independent string system are allowed to act upon the other linked string system, resulting in a cumulative, single wave frequency.

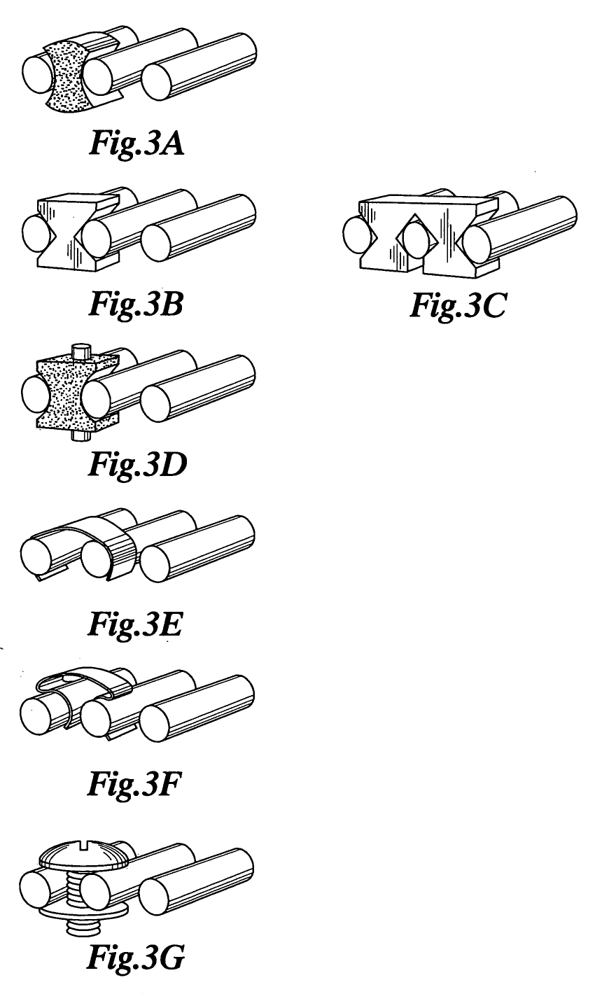

FIG. 3 shows different embodiments of the invention. In FIG. 3-A, strings can be coupled with soft materials such as dense felt or rubber. In FIG. 3-B-1, strings can be coupled with harder, less absorbent materials such as wood or metal to extend the sustain capabilities of the coupled strings. In FIG. 3-B-2, coupling can be extended to tripling if harder materials are used. In FIG. 3-C, soft materials can be fortified with heavier mass such as metal pins to adjust their dampening effect on the coupled strings. In FIG. 3-D, metal spring links can also be used to compress strings together and maintain solid contact. In FIG. 3-E, metal spring links can also compress strings away from each other. In FIG. 3-F, screw-type fasteners or similar fasteners can be used to secure the coupling device through compressive force.

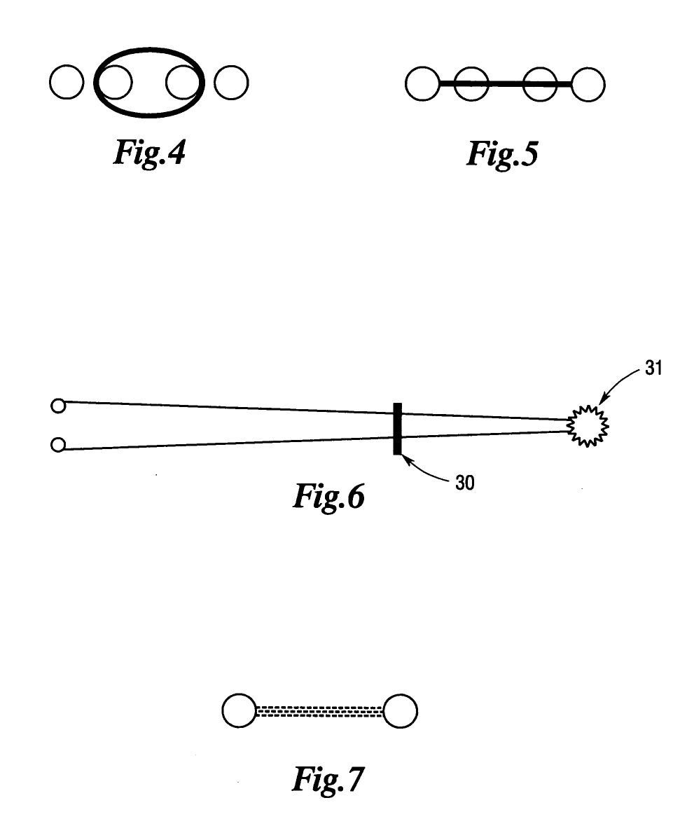

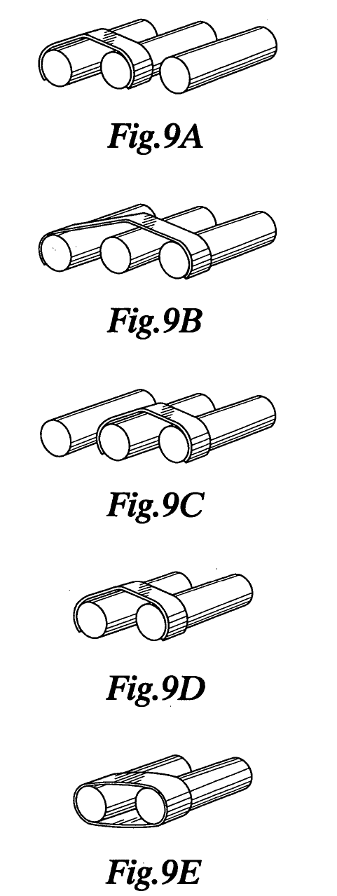

As shown in FIG. 4, the coupling can occur through slightly pulling two strings together, as with the coupling depicted in FIG. 3D. As shown in FIG. 5, the coupling can also be created by slightly pushing the strings apart, as with the couplings depicted in FIGS. 3A, 3B1, 3B2, 3C, and 3E. Similarly, the coupling can occur simply by mechanically linking the strings, such as depicted in FIG. 3F, or through the semi-rigid link, shown in FIG. 7, that is engineered to allow transmission of specific frequencies, dependant upon the resonance and transmission properties of the link. In most applications, the most practical method and device for coupling strings is as generally shown in FIG. 3D and in FIG. 9.

FIG. 9 shows alternate embodiments of metal couplings. In FIG. 9A, two strings of a three-string unison are coupled by a lightweight metal spring link. In FIG. 9B, a metal link spans the middle string to couple the two outer strings of a three-string unison. In FIG. 9C, the right pair of strings can equally be coupled. In FIG. 9D, two strings of a two-string unison can be coupled. In FIG. 9E, through expansive forces as opposed to contractive forces any of the above scenarios can make use of a continuous loop link.

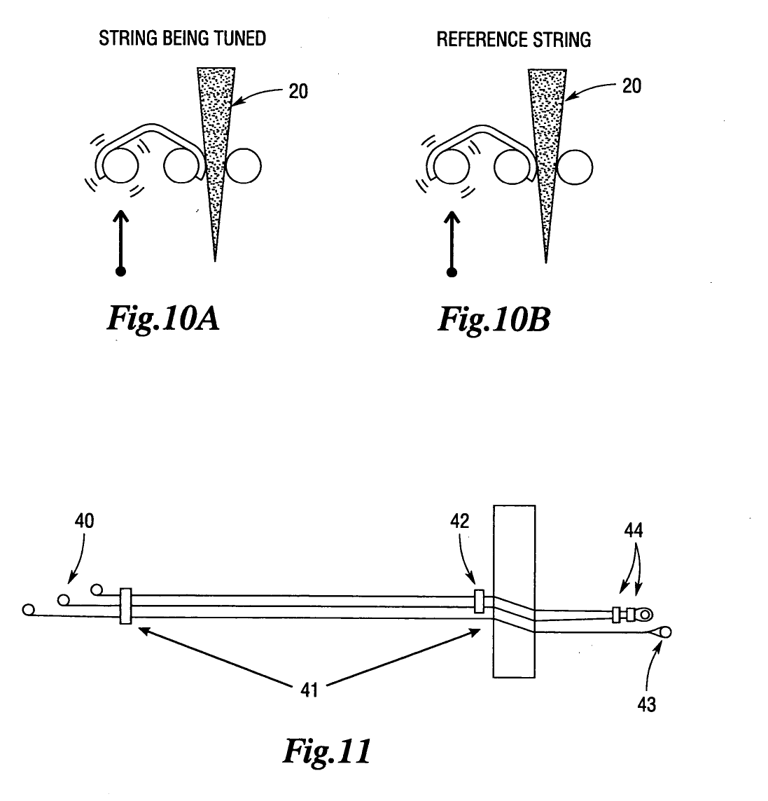

FIG. 10 shows a typical muting pattern when tuning coupled strings. The figures refer to two, independent trichord notes. A soft wedge is dampening the two right strings in each case. Since the wedge is contacting one of the coupled strings, it will affect the pitch of the other coupled string that is being tuned (A). Therefore the string used for reference to tune the coupled string should also include a coupling and wedge to reflect the same frequency change (B). FIG. 10A is the note that is being tuned. FIG. 10B is a previously tuned reference point.

The process of coupling can also extend to include various material configurations. Material properties of the invention play a key role in its effect on piano tone. While a wide spectrum of musical tones can be produced through materials modifications, experimentation indicates that materials with high stiffness and low mass produce optimum results. Very soft materials such as low density felts, are not desirable because their damping properties produce a dull, short tone. Conversely, very dense materials typically exhibit high mass which also dampens tone. Ideal materials combine low mass and/or high stiffness. Plastic materials, such as rubber, work within a durometer range of 40-60, depending on the size of the material used. Medium to hard density wood species such as mahogany and maple can be used if dimensionally small. Metals such as steel, aluminum or titanium work well but must be dimensionally smaller than other softer material choices.

Once in place, a coupling will alter the conventional method for unison tuning. When two strings are coupled, neither can be muted or tuned without affecting the other paired string. Therefore, when a mute contacts either coupled string, the other coupled string will produce a muted, slightly elevated pitch. If this pitch is tuned against another note, as in the case of temperament tuning, then the other reference pitch should also reflect the effects of similar muting. For instance, FIG. 6 depicts an overhead view of tensioned strings connected by a rigid link (A) or coupling. The two strings share a single tension adjustment device (B). The coupling will assimilate the two oscillatory patterns, even if tensions are unevenly changed by the adjustment device. FIG. 10 shows a typical muting/tuning configuration for notes containing coupled strings.

FIG. 11 shows an advanced embodiment of the invention. It depicts an overhead view of a three-string unison with tuning pins (A), two speaking length terminations (B), a coupling link (C) and hitch pins (D). The configuration depicted allows one to easily maintain the tuning of a three string unison by sliding a link similar to the coupling (E) across the non-speaking string length. Additionally, the note contains two crimping links in the nonspeaking portion of the string (E). If the left link is slid to the left, then the cumulative pitch of the coupled pair will be elevated. These two links do not serve as couplings to allow unison oscillations, but serve as a simple way to adjust the pitch of both coupled strings. Coupling link (C) will hold the two string pitches together if the sliding band causes minor differences in string tension. Use of the slideable tuning links further delays pitch drift, a common source of unison distuning.

As stated, the use of couplings between unison piano strings has been shown to effectively reduce the presence of unison distuning. Yet a further benefit of the invention is that once the links are installed in a unison instrument, the length of time required to tune the instrument can be decreased.

Enhanced Tonal Qualities

In addition to the benefits of unison pitch stabilization and simplified tuning procedures, the invention can create beneficial effects upon piano tone quality. As an example, string coupling produces a cumulative, single wave amplitude attack rate, and produces a cumulative, single wave amplitude decay rate. These characteristics can enhance the sound of a piano.

A typical piano tone can be described as a percussive pitch of short duration, exhibiting three distinct segments of sound. Attack is the initial, strongest spike of volume, produced when maximum energy is transmitted through the string medium into the soundboard. This is the shortest segment of sound within the tone envelope. Frequencies produced during the attack phase are usually very high within the overtone series. Therefore, attack sound is typically bright and short. After the initial surge of attack sound, the tone envelope displays a brief leveling off of amplitude during which mid level overtone frequencies prevail at a somewhat constant rate. This segment of sound is prized among piano manufacturers as the most musically satisfying portion of a piano's tone. Pianos with long sustain are usually considered to be tonally superior. Decay is the gradual reduction of amplitude leading to tone termination. This is the longest segment within the envelope. A standard typical piano tone envelope would appear as follows:

[image]

The invention, through its constraining properties, limits the free release of certain overtone frequencies, primarily in the higher frequency range. This is reflected within the tone envelope as a reduced attack spike. Since attack is the shortest and loudest portion of the envelope, its subsequent reduction changes the overall tonal characteristic of coupled strings. In embodiments where coupled strings resonate alongside unrestrained strings within a unison, a new tone envelope can emerge with the perception of less attack properties. After placement of a coupling, the modified piano tone envelope would be as follows:

[image]

As another example, the invention may be used to increase tonal projection in certain regions of the piano. For instance, the links may be installed selectively only in certain regions of the piano for the express purpose of effecting the tone of those strings.

According to another aspect of the invention, any harmonic anomalies present within either single string can be masked, diminished or eliminated from the sounding harmonic spectrum of the two-string system. Such anomalies might include, physical imperfections within either string, imperfections at a string termination point, or inharmonic modes of vibration which are significantly dissonant to the harmonic overtone series of a string. Masking, diminishing or eliminating such anomalies can be beneficial toward producing more harmonic tone quality in musical instruments.

As yet another benefit, said coupling produces a cumulative, single medium for future frequency or amplitude adjustment within the linked string system.

### EXAMPLES

This coupling device has been installed as described in approximately seven thousand string unisons, and results in a consistent phenomena of creating a coupled harmonic oscillation wherein the coupled strings constitute a new oscillating object with a new, single resonant frequency. This result may be measured and confirmed through use of spectrographic or oscilloscopic analysis.

### Example 1

Application of heat to piano strings causes their frequencies to drop. By stroking or swiping strings with a rubber wedge, controlled “doses” of frictional heat can be applied to individual strings within a unison note. This provides a reliable method for analyzing unison distuning tendencies. It is also a convenient way to compare coupled string unisons with conventional ones.

The chart set forth in FIG. 14 graphs the patterns of distuning exhibited by piano strings when incremental heat is applied. The headings, 70 indicate what type of notes are displayed. The triangles, 72 represent rubber wedges. They quantify and point to the location within each trichord where swiping (application of heat) was directed. Below the triangles are 3 circlular cross sections of the trichord strings. Their numbers, 74 reflect how many strokes from the wedges were applied to each string. Overlapping swipes cause the middle strings to collect higher “doses” of heat. In the coupled note on the right of the chart, the right pair of strings is joined by a coupling, 76, represented by the horizontal bracket over those strings. The region below the string cross sections graphically displays the incremental pitch change (flattening) that occurs for each string when units of heat are applied. Finally, the legend on the right differentiates the three types of pitches being displayed.

In this example, heat has altered all three strings of both notes equally. The conventional note will produce distuning between each possible string pair. This note will sound dissonant and out of tune. In the other unison, coupling has caused the two right strings to combine and form a single frequency, identical to that of the third conventional string. Therefore the coupled string unison displays no distuning. String coupling pursuant to the instant invention can produce up to 100% less distuning than in the conventional note.

### Example 2

A 1955 Mehlin & Sons, NY, 5′0″ Grand Piano, Serial No. 50804, was used for testing the invention. The piano was exposed to significant, measurable, environmental changes, including unhumidified, dry heat from a coal furnace, unconditioned humid air, and air conditioning, with annual temperature ranges from 58 degrees to 82 degrees F. Prior to placement of the couplings, the owner required a tuning at least every three months, and in any event, with every change in season, and consequent change in the room's environment. The piano was in average aged condition, with corroded strings and pin blocks and pins in average condition. After installation of the couplings, the piano tolerated three separate seasonal environmental changes prior to any noticeable distuning in any of the string unisons. This Mehlin grand piano also demonstrated a perceptable improvement in tonal quality after placement of the couplings. The specific model of piano is known to have a more harsh, or “nasal” tonal quality, due in part to the uncharacteristically short distance from the string termination point to the point where the hammers engage the strings (approximately 1/12^{th} the string length). After installation of the couplings, the sound of the piano was perceptibly warmer and richer. In this instance, the coupled harmonics dissipate the harsh “bite” of the piano sound.

### Example 3

Pianos employing string couplers have been successfully tested at the Tanglewood Music Festival in Lennox, Mass. This festival receives approximately 100 new pianos each year. Unison distuning is especially prevalent due to the following factors: (1) the pianos are brand new; (2) the environment has no humidity or temperature control; and (3) the pianos are heavily used by a transient student population.

In side-by-side comparisons, pianos with string couplers exhibited noticeably more stable unison tuning. Student piano tuners were successfully trained to install and service the string couplers. Increased tuning longevity was documented through electronic recordings made in a professional recording facility located on the premises. At the conclusion of the festival, all string couplers were removed with no damage or alteration having been caused to the strings or to the pianos.

Specifications for Device and Installation Tools

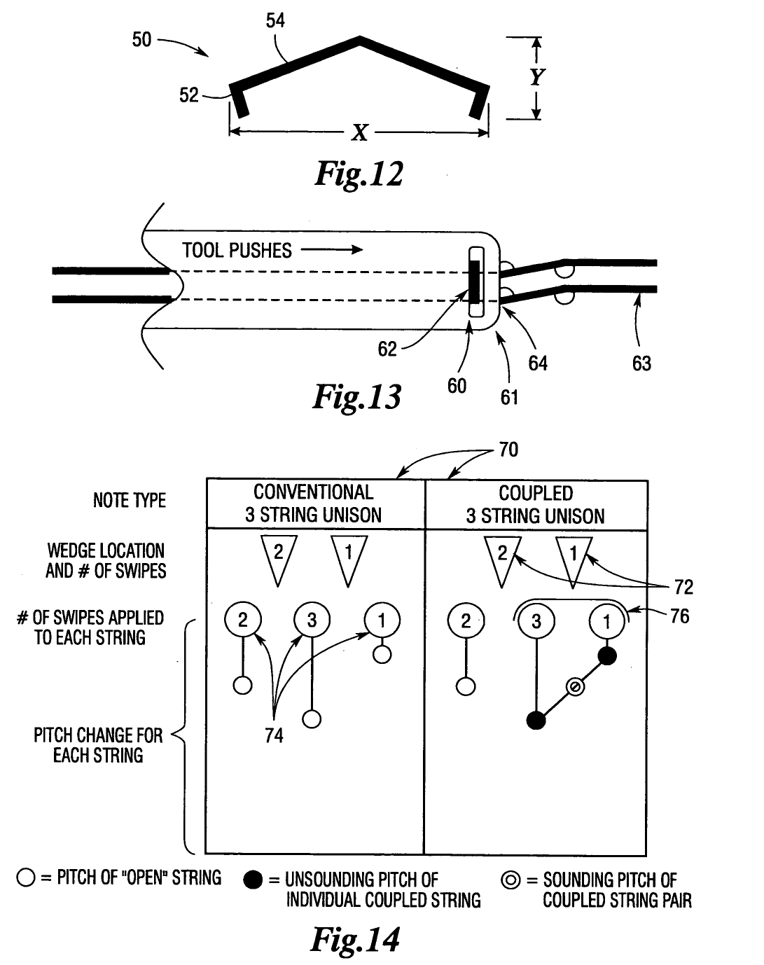

In one preferred embodiment to the invention, a light weight metal link (steel, aluminum or titanium) is friction fit around two unison strings. Only by way of illustration and example, a readily available material for prototyping was found in stock, flat steel which can be trimmed and reformed as described in FIG. 12 to produce couplings 50 that span two of the three strings within a typical piano unison. The preferred shape of these couplings contains short vertical legs 52 for grasping the piano strings, with a topside bend 54 in the horizontal portion of the structure. The top bend can be adjusted to accurately fit the coupling onto the strings with proper crimping force. There are many other materials suitable for creating such a coupling that are well known to those skilled in the art.

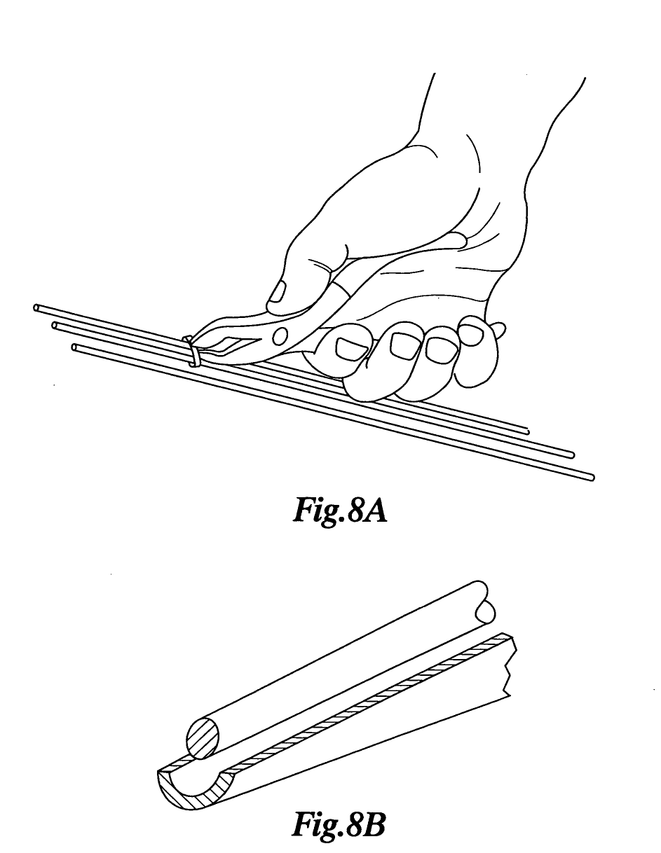

A small bending crimper/plier (“crimping plier”) has been identified to achieve this installation, as depicted in FIG. 8. Squeezing the tool's handles closes the link tighter around the pair of strings being coupled. This technique permits accurate adjustment of link clamping force. In a preferred embodiment of the invention, the couplings and tools are assembled in a customized tuning “kit,” containing a pre-sized set of links, and the crimping tool for individually fitting each link to a given unison string pair. FIG. 8A shows the tool placing the coupling onto two strings of a unison. FIG. 8B shows an end view of the tool. For instance, jewelers' ring bending pliers may be used with a cylindrical jaw of from 1/32″ to ¼″, and preferably of 1/16″, and an opposing concave jaw with a width of from ⅛″ to ½″ but preferably ¼″. The depth of the concave jaw must be sufficient to create a coupled harmonic oscillator. The crimping plier tool may be calibrated through use of set screws and stops well known in the art to produce consistent or precalibrated crimping dimensions suitable for specific instruments. Additionally, the jaw may be magnetic, and/or use other mechanical means, to more easily handle the couplings during installation. The coupling is placed over a horizontal string pair, then crimped with the pliers until a correct fit is established. The optimum fit for these couplings is generally found to exist close to (⅛ inch) either of the strings two speaking length terminations. In both locations, the clamping force of the link should be minimal to avoid excessive dampening of the strings, but not too loose to create buzzing or rattling against the vibrating strings. Once in place, the coupled strings will produce a single primary frequency which can be tuned by relocating the link along the string length. Nevertheless, optimum tonal quality will still be gained from maintaining a link position in close proximity to the string termination. A preferred range of placement of the links during installation is as follows: for the bridge-end termination approximately 1/32″ to ¼″, and more preferably from approximately 1/16″ to ⅛″, and for the non-bridge end termination, approximately 1/32″ to ½″, and more preferably, from approximately 1/16″ to ¼″.

The process of coupling with links can be extended to include various geometric configurations. All embodiments employ the basic concept of linking together strings of similar pitch. FIG. 9 shows variations of this concept. In addition, as stated above, couplings can be installed between two strings. In this instance, an expander tool would be required to separate the two strings to be coupled a sufficient distance to allow placement of the coupling as depicted, for instance, in FIGS. 3C and 3E. As one means for such a tool, the coupling rests on the inside of the tool's expansion “jaws,” and once the strings have been separated, the coupling slides to the distal end of the jaws, and onto the strings. When the expander is released, the coupling remains in place between the coupled strings.

An easy method for positioning couplings onto piano strings involves the use of a special tool, designed to both slide and accurately position couplings along the string lengths. FIG. 13 shows a thin, flexible tool of metal or similar sturdy material and slotted near its tip. The slot (A) fits over a coupling (C) which has been placed onto the string pair (D). When the tool is pushed, the coupling is made to slide down the string length until the tool tip (B) comes to rest against the bridge pin string termination (E). The distance from the slot to the tip of the tool (AB) produces a consistent coupling location. Use of the tool can greatly simplify installation of the Pitchlock couplings in certain installation conditions, including upright pianos, and some grand piano configurations.

While the invention has been particularly shown and described with reference to preferred embodiments thereof, it will be understood by those skilled in the art that various alterations in form and detail may be made therein without departing from the spirit and scope of the invention.

What is claimed:

1. A unison stringed instrument containing a device for increasing tuning longevity comprising:
a coupling positioned between two or more strings of at least one string unison of said instrument, said coupling enabling the coupled strings to oscillate in unison.

2. A unison stringed instrument containing a device for increasing tuning longevity comprising:
a coupling positioned around two or more strings of at least one string unison of said instrument, said coupling enabling the coupled strings to oscillate in unison.

3. A device for increasing tuning longevity of a unison stringed instrument, comprising:
a coupling positioned between two or more strings of at least one string unison of said instrument, said coupling enabling the strings to oscillate substantially in unison.

4. A device for increasing tuning longevity of a unison stringed instrument, comprising:
a coupling positioned around two or more strings of at least one string unison of said instrument, said coupling enabling the strings to oscillate substantially in unison.

5. The device of claim 3 or 4, wherein said coupling comprises a high tensile metal.

6. The device of claim 5, wherein said high tensile metal comprises steel, aluminum or titanium.

7. The device of claim 3, wherein said coupling is fastened between the strings of said string unison using a tool that is capable of installing the coupling in a manner sufficient for enabling said strings to oscillate in unison at a desired pitch.

8. The device of claim 4, wherein said coupling is fastened around the strings of said string unison using a crimping tool that is capable of supplying a level of compression sufficient for enabling said strings to oscillate in unison at a desired pitch.

9. A system for increasing tuning longevity of a unison stringed instrument, comprising:
(a) a plurality of couplings sized and arranged within said unison stringed instrument, each coupling being positioned between two or more strings of a string unison of said instrument; and
(b) an installation tool for expanding the strings to a degree adequate for installation of said couplings.

10. A system for increasing tuning longevity of a unison stringed instrument, comprising:
(a) a plurality of couplings sized and arranged within said unison stringed instrument, each coupling being positioned around two or more strings of at least one string unison of said instrument; and
(b) a crimping tool having preset crimping compression values suitable for each size of said couplings.

11. A method for increasing tuning longevity of a unison stringed instrument, comprising:
coupling two or more strings of at least one string unison of said instrument with a coupling device so that the strings oscillate in unison at a desired pitch.

12. A method for increasing tuning longevity of a unison stringed instrument, comprising:
employing a crimping tool to couple two or more strings of at least one string unison of said instrument with a coupling so that the strings oscillate in unison.

13. A device for increasing tuning longevity of a unison stringed instrument, said device comprising:
(a) a shaped piece of material having high density and minimal dampening; and
(b) a plurality of recesses for receiving two or more strings in unison, wherein the size and shape of the device enable coupling of adjacent strings of said instrument, allowing the strings to produce a unified resonant frequency.

14. A device for increasing tuning longevity of a unison stringed instrument, said device comprising:
an open metal band curved and shaped so that said band compresses when placed over two adjacent strings of said instrument, wherein the size and shape of the device enable coupling of said adjacent strings, allowing the strings to produce a unified resonant frequency.

15. A device for increasing tuning longevity of a unison stringed instrument, said device comprising:
a metal clip curved and shaped so that when placed between two adjacent strings of said instrument, said clip exerts opposing forces on the strings,
wherein the size and shape of the device enable coupling of said adjacent strings, allowing the strings to produce a unified resonant frequency.

16. A device for increasing tuning longevity of a unison stringed instrument, said device comprising:
a first and second flat surface, said first flat surface being positioned above adjacent strings of said instrument, said second flat surface being positioned below said adjacent strings, said surfaces capable of being tightened toward each other,
wherein the size and shape of the device enable coupling of said adjacent strings, allowing the strings to produce a unified resonant frequency.

17. A method of altering the tone quality of a unison stringed instrument, comprising placing coupling devices between two or more strings of a string unison of said instrument, said device comprising:
an open metal band curved and shaped so that said band compresses when placed over two adjacent strings of said instrument,
wherein the size and shape of the device enable coupling of said adjacent strings, allowing the strings to produce a unified resonant frequency.

18. A method of altering the tone quality of a unison stringed instrument, comprising limiting the free release of certain overtone frequencies by placing coupling devices between two or more strings of a string unison of said instrument, said device comprising:
an open metal band curved and shaped so that said band compresses when placed over two adjacent strings of said instrument,
wherein the size and shape of the device enable coupling of said adjacent strings, allowing the strings to produce a unified resonant frequency.

19. The method of claim 17 wherein the ratio of sustain to attack is increased.

20. A method for maintaining the tuning of a string unison within a musical instrument comprising the steps:
(a) installing a coupling link for at least two of the stings in the unison along their speaking length;
(b) installing at least one crimping link in the non-speaking portion of the stings;
(c) tuning the string unison; and
(d) sliding one or more of the crimping links in either direction along the non-speaking length to adjust the pitch of the coupled strings.

21. A device for the installation of Pitchlock coupling devices comprising a flexible steel strap of sufficient length, wherein the strap includes a notch of sufficient size to accommodate the pitchlock coupling device, and wherein the notch is between 1/16 and ½ an inch from the terminal end of the strap.

22. A device for installing Pitchlock coupling devices comprising a crimping plier, with two mated jaws, wherein one jaw is substantially convex in cross section, and the other jaw is concave in cross section.
